(19) United States
(12) Patent Application Publication
(10) Pub. No.: US 2006/0151914 A1
(43) Pub. Date: Jul. 13, 2006

(54) Device and process for treating flexible web by stretching between intermeshing forming surfaces

(76) Inventors: Robert James Gerndt, Roswell, GA (US); Jose Enrique Maldonado, Dunwoody, GA (US); Ann Louise McCormack, Cumming, GA (US); Michael Tod Morman, Knoxville, TN (US)

Correspondence Address: KIMBERLY-CLARK WORLDWIDE, INC., 401 NORTH LAKE STREET, NEENAH, WI, 54956, US

(21) Appl. No.: 10/525,636

(22) PCT Filed: Aug. 22, 2003
(86) PCT No.: PCT/US03/26247

§ 371 Date: Feb. 24, 2005

Related U.S. Application Data
(60) Provisional application No. 60/407,172, filed on Aug. 30, 2002.

(51) Int. Cl. B29C 55/06; B29C 55/08

(52) U.S. Cl. 264/288.4; 264/290.2; 425/363; 425/396

(57) ABSTRACT

A series of nips (200, 202, 204, 412, 414) formed by intermeshing grooves (22, 24, 26, 28) provides for a higher degree of stretch, particularly for lightweight webs (100) by stretching in stages in multiple grooved nips. The ability to adjust the degree of stretch at each nip can provide a high degree and variability of stretch with reduced web damage compared to a single step application of the same stretch. Improvements to the manufacture of lightweight components of personal care products such as diaper backing components are obtained.

### FIELD OF THE INVENTION

This invention is directed to a method and apparatus for applying variable and incremental stretch forces to a flexible web by multiple contacts with a mechanism that forces the web into grooves of a support surface using mating engagement means. The invention finds application, for example in the manufacture of nonwoven fabrics, including spunbond nonwovens, as well as laminates with other nonwovens and/or films. Advantages include the ability to apply increasing stretch forces, particularly for lightweight webs without damage to the web and to widely vary the degree of stretch applied using a single device. More particularly, this invention is directed to a controlled application of stretching forces in an incremental manner resulting in improved web properties and economy of manufacture. The design of the stretching means can conveniently include grooved rolls and/or belts depending on the material being treated and the desired results. The invention also includes a method of producing controlled application of stretching forces incrementally using multiple impacts as well as the resulting treated webs that can be tailored to achieve a wide variety of physical and other properties for numerous applications in personal care, health care, protective apparel and industrial products.

### BACKGROUND

Nonwoven fabrics or webs, alone or as a laminate with other nonwovens or films, constitute all or part of numerous commercial products such as adult incontinence products, sanitary napkins, disposable diapers, swimwear, and hospital drapes and gowns, just to name a few. Nonwoven fabrics or webs have a physical structure of individual fibers, strands or threads which are interlaid, but not in a regular, identifiable manner as in a knitted or woven fabric. The fibers may be continuous or discontinuous, and are frequently produced from thermoplastic polymer or copolymer resins from the general classes of polyolefins, polyesters and polyamides, as well as numerous other polymers. Fibers from blends of polymers or conjugate multicomponent fibers may also be employed. Methods and apparatus for forming fibers and producing a nonwoven web from synthetic fibers are well known; common techniques include meltblowing, spunbonding and carding. Nonwoven fabrics may be used individually or in composite materials as in a spunbond/meltblown (SM) laminate or a three-layered spunbond/meltblown/spunbond (SMS) fabric. They may also be used in conjunction with films and may be bonded, embossed, treated or colored. Colors may be achieved by the addition of an appropriate pigment to the polymeric resin. In addition to pigments, other additives may be utilized to impart specific properties to a fabric, such as in the addition of a fire retardant to impart flame resistance or the use of inorganic particulate matter to improve porosity. Because they are made from polymer resins such as polyolefins, nonwoven fabrics are usually extremely hydrophobic. In order to make these materials wettable, surfactants can be added internally in the melt for example or externally by various coating or application steps. Furthermore, additives such as wood pulp or fluff can be incorporated into the web to provide increased absorbency and decreased web density. Such additives are well known in the art. Bonding of nonwoven fabrics can be accomplished by a variety of methods typically based on heat and/or pressure, such as through air bonding and thermal point bonding. Ultrasonic bonding, hydroentangling and stitchbonding may also be used. There exist numerous bonding and embossing patterns that can be selected for texture, physical properties and appearance. Qualities such as strength, softness, elasticity, absorbency, flexibility and breathability are readily controlled in making nonwovens. However, certain properties must often be balanced against others. An example would be an attempt to lower costs by decreasing fabric basis weight while maintaining reasonable strength. Nonwoven fabrics can be made to feel cloth-like or plastic-like as desired. The average basis weight of nonwoven fabrics for most applications is generally between 5 grams per square meter and 300 grams per square meter, depending on the desired end use of the material. Nonwoven fabrics have been used in the manufacture of personal care products such as disposable infant diapers, children's training pants, feminine pads and incontinence garments. Nonwoven fabrics are particularly useful in the realm of such disposable absorbent products because it is possible to produce them with desirable cloth-like aesthetics at a low cost. Nonwoven personal care products have had wide consumer acceptance. The elastic properties of some nonwoven fabrics have allowed them to be used in form-fitting garments, and their flexibility enables the wearer to move in a normal, unrestricted manner. The SM and SMS laminate materials combine the qualities of strength, vapor permeability and barrier properties; such fabrics have proven ideal in the area of protective apparel. Sterilization wrap and surgical gowns made from such laminates are widely used because they are medically effective, comfortable and their cloth-like appearance familiarizes patients to a potentially alienating environment. Other industrial applications for such nonwovens include wipers, sorbents for oil and the like, filtration, and covers for automobiles and boats, just to name a few.

Films, as mentioned, are another common component, in many cases as a breathable barrier layer for increased comfort. Breathable microporous films can be formed by any one of various methods known in the art. For example, such films can comprise filled films which include a thermoplastic polymer and filler. These and other desired additives can be mixed together, heated and then extruded into a monolayer or multilayer film. Examples are described in WO 96/19346 to McCormack et al., incorporated herein by reference in its entirety. The film may be made by any one of a variety of film forming processes known in the art such as, for example, by using either cast or blown film equipment. The thermoplastic film can then be stretched in accordance with the invention, either alone or as part of a laminate to impart breathability or other desired properties.

It is widely recognized that properties relating to strength, softness and barrier of nonwoven fabrics and films are desirable for many applications and are sometimes somewhat conflicting. Barrier, for example, can be increased by combining the nonwoven with another layer such as a film, but the combination may then have increased stiffness or noise (rattle). For this reason, as well as for economy, it is desirable to use films and nonwovens that are as thin as possible while still imparting the desired barrier or other properties. Softness can be improved by various mechanical steps including controlled stretching of the nonwoven to break secondary bonds that tend to stiffen the material. Particularly for thin nonwovens and laminates, incremental stretching along lines using grooved rolls, for example, has been described as a way to treat such webs for these properties and to provide stretch or extensibility depending on the nature of the web. Moreover, film stretching thins the film and thus extends its coverage for increased economy. These stretching attempts have included the use of multiple devices that stretch the web at different stations in the web processing line. However, such processes have tended, particularly with lightweight webs or laminates, to damage one or both layers or to provide only a limited degree of flexibility in treating the webs, particularly those with a basis weight in the range of from about 10 gsm to about 150 gsm, for example. The present invention addresses these and other opportunities for improvement.

### SUMMARY OF THE INVENTION

The present invention includes the use of a unitary device that provides multiple impact incremental stretching of a flexible web in an arrangement that permits a high degree of flexibility in terms of degree of stretch and that allows stretching in stages, particularly adapted to treat lightweight webs within the basis weight range of from about 10 gsm to about 150 gsm with a minimum of web damage. Broadly, the invention is useful in treating webs, including single sheets and/or laminates, in the range, for example, of 5 to 400 gsm, particularly about 10 to about 100 gsm. Especially for laminates including very thin film layers, for example, the invention provides for high speed operation over extended periods of continuous operation time and the ability to widely vary the degree of stretch without major equipment downtime for modification. Particularly when used to treat laminates such as those containing film and spunbond nonwoven components for disposable diaper cover applications which can include webs within the basis weight range of from about 10 gsm to about 50 gsm or in some cases 10 gsm to 30 gsm, the resulting process and arrangement allows very thin films and nonwoven layers with reduced levels of film or nonwoven tears or defects. In one embodiment, the arrangement consists of a large anvil grooved roll in moving engagement with multiple satellite grooved mating rolls around the circumference of the anvil roll. In a second embodiment, an anvil grooved belt is used in moving engagement with successive multiple grooved mating rolls in line. In all cases, the degree of engagement of the grooves can be varied to produce the desired level of stretch in stages thereby avoiding the web stress that would be necessary in a single stretching stage. The number of engagements can also be varied by increasing or decreasing the number of contacts, and the degree of groove penetration can also be easily varied by adjusting the nip between the mating rolls and anvil surface. In one embodiment, the web can be separated from the anvil surface between impacts to provide varying degrees of randomness in the lines of impact on the web. The invention is applicable to treating a wide variety of webs and using many different contact configurations.

The invention provides a process for forming a nonwoven web including the steps of:
a. providing a web material;
b. providing a forming surface having grooves formed therein;
c. providing a plurality of mating surfaces having raised areas or fins positioned to fit within the grooves of said forming surfaces;
d. forming successive nips between the forming surface and the mating surfaces wherein the raised areas of the mating surfaces enter the grooves of the forming surface at separate locations on the forming surface;
e. feeding said sheet material into the successive nips while in position on the forming surface; and
f. stretching said sheet material a plurality of times at locations on the sheet material by the raised areas entering the forming surface grooves within successive nips.

In an alternative embodiment the raised areas of said successive mating surfaces enter the grooves of respective successive nips to a different degree providing a different amount of stretch to said sheet at different nips.

In one embodiment the forming surface is a drum and the plurality of mating surfaces are satellite rolls positioned at different locations with respect to said drum. Alternatively, the forming surface may be a grooved belt with successive grooved or finned rolls at different locations along the belt.

In each embodiment the spacing and depth of the respective grooves and mating surfaces may be widely varied to produce the desired properties in the treated web. The shape of the respective grooves and mating surfaces may also be varied to control the degree, if any, of web compression desired. In a specific embodiment suitable, for example, for treating lightweight film/nonwoven laminates, the number of grooves and corresponding fins per inch may be in the range of about 3 to about 15, the shape of the grooves may be triangular or rectangular with radius (rounded) edges, the mating surface raised areas or fins may also be triangular or rectangular and penetrate the grooves to a depth that will be determined by factors such as the number of impacts and the degree of stretch desired, often, for example, up to about 4× for many of the above described applications. The shape may be selected to that it maintains separation between the sides and avoids compression of the web if desired. Also, in one aspect the penetration of the raised areas may be successively varied to as to increase or decrease the stretching of the web at different nip contact points. In another aspect of the present invention, the location of successive contacts on the web may be controlled to provide that each contact occur along a previously stretched line or may be varied by, for example, separating the web from the support surface between contacts so that contact occurs at various and generally random lines successively. The invention also includes the apparatus and resulting treated webs.

### BRIEF DESCRIPTION OF THE DRAWINGS

FIG. 1 is a schematic illustration of a multiple impact incremental machine direction stretching device of the invention in an anvil roll and satellite roll configuration.

FIG. 2 is an enlarged view of two of the nips between the anvil roll and two of the satellite rolls of FIG. 1 with a web passing through showing a different degree of penetration into the anvil roll grooves by the successive nip.

FIG. 3 is a view like that of FIG. 2 showing a schematic illustration of an embodiment using a where the web is separated from the anvil roll between nips to produce random lines of stretching.

FIG. 4 illustrates an alternative embodiment using an anvil belt instead of an anvil roll.

FIG. 5 is a view of an alternative arrangement with circumferential grooves and fins for cross-machine direction (CD) stretching of the web.

FIG. 6 is a detailed partial view of an engaged nip configuration.

FIG. 7 is a schematic of an overall laminate process configuration incorporating the present invention.

### DETAILED DESCRIPTION

### Definitions

As used herein and in the claims, the term “comprising” is inclusive or open-ended and does not exclude additional unrecited elements, compositional components, or method steps.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein the term “microfibers” means small diameter fibers having an average diameter not greater than about 75 microns, for example, having an average diameter of from about 0.5 microns to about 50 microns, or more particularly, microfibers may have an average diameter of from about 2 microns to about 25 microns. Another frequently used expression of fiber diameter is denier, which is defined as grams per 9000 meters of a fiber and may be calculated as fiber diameter in microns squared, multiplied by the density in grams/cc, multiplied by 0.00707. A lower denier indicates a finer fiber and a higher denier indicates a thicker or heavier fiber. For example, the diameter of a polypropylene fiber given as 15 microns may be converted to denier by squaring, multiplying the result by 0.89 g/cc and multiplying by 0.00707. Thus, a 15 micron polypropylene fiber has a denier of about 1.42 (15²×0.89×0.00707=1.415). Outside the United States the unit of measurement is more commonly the “tex”, which is defined as the grams per kilometer of fiber. Tex may be calculated as denier/9.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface and the web is normally subjected to a bonding step such as thermal point bonding, ultrasonic bonding, adhesive bonding or the like. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes. Spunbond fibers may be monocomponent, conjugate and/or biconstituent as is know to those skilled in the art.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein “multilayer laminate” means a laminate wherein one or more of the layers may be spunbond and/or meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (6 to 400 gsm), or more particularly from about 0.75 to about 3 osy. Multilayer laminates for many applications also have one or more film layers which may take many different configurations and may include other materials like foams, tissues, woven or knitted webs and the like.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” includes all possible geometrical configurations of the molecule. These configurations include, but are not limited to isotactic, syndiotactic and random symmetries.

As used herein, the term “machine direction” or MD means the length of a web in the direction in which it is produced. The term “cross machine direction” or CD means the width of fabric, i.e. a direction generally perpendicular to the MD.

As used herein the term “monocomponent” fiber refers to a fiber formed from one or more extruders using only one polymer. This is not meant to exclude fibers formed from one polymer to which small amounts of additives have been added for color, antistatic properties, lubrication, hydrophilicity, etc. These additives, e.g. titanium dioxide for color, are generally present in an amount less than 5 weight percent and more typically about 2 weight percent.

As used herein the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., U.S. Pat. No. 5,540,992 to Marcher et al. and U.S. Pat. No. 5,336,552 to Strack et al. Conjugate fibers are also taught in U.S. Pat. No. 5,382,400 to Pike et al. and may be used to produce crimp in the fibers by using the differential rates of expansion and contraction of the two (or more) polymers. Crimped fibers may also be produced by mechanical means and by the process of German Patent DT 25 13 251 A1. For two component fibers, the polymers may be present in ratios of 75/25, 50/50, 25/75 or any other desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. Nos. 5,108,827 and 5,294,482 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein the term “blend” means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

“Bonded carded web” refers to webs that are made from staple fibers which are sent through a combing or carding unit, which breaks apart and aligns the staple fibers in the machine direction to form a generally machine direction-oriented fibrous nonwoven web. Such fibers are usually purchased in bales which are placed in a fiberizer which separates the fibers prior to the carding unit. Once the web is formed, it then is bonded by one or more of several known bonding methods. One such bonding method is powder bonding, wherein a powdered adhesive is distributed throughout the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

As used herein, “ultrasonic bonding” means a process performed, for example, by passing the fabric between a sonic horn and anvil roll as illustrated in U.S. Pat. No. 4,374,888 to Bornslaeger.

As used herein “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern looking as the name suggests, e.g. like a window screen, with about a 19% bond area. Typically, the percent bonding area varies from around 10% to around 30% of the area of the fabric laminate web. As in well known in the art, the spot bonding holds the laminate layers together as well as imparts integrity to each individual layer by bonding filaments and/or fibers within each layer.

As used herein, the term “bond” and derivatives does not exclude intervening layers between the bonded elements that are part of the bonded structure unless the text requires a different meaning.

As used herein, the term “personal care product” means generally absorbent products for use to absorb and/or dispose of bodily fluids, including but not limited to diapers, training pants, swimwear, absorbent underpants, adult incontinence products, and feminine hygiene products. It also includes absorbent products for veterinary, medical and mortuary applications.

As used herein, the term “protective cover” means a cover for vehicles such as cars, trucks, boats, airplanes, motorcycles, bicycles, golf carts, etc., covers for equipment often left outdoors like grills, yard and garden equipment (mowers, rototillers, etc.) and lawn furniture, as well as floor coverings, table cloths and picnic area covers. It also includes covers for medical applications such as surgical drapes, gowns, etc.

### Description

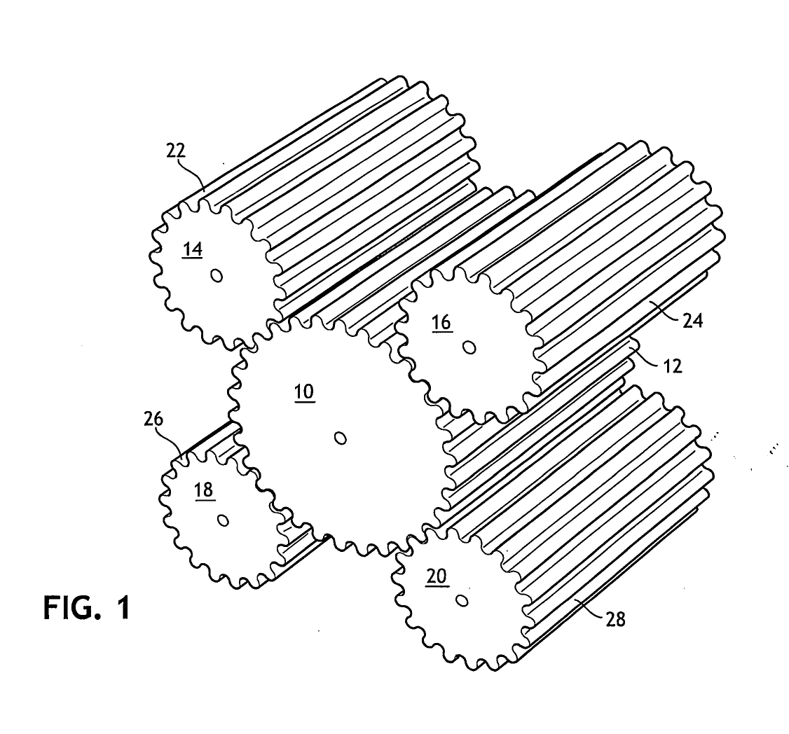

Turning to FIG. 1, there is shown a schematic illustration of one embodiment of the invention using an anvil roll and four satellite rolls with the grooves greatly enlarged for clarity. As shown, anvil roll 10 includes about its periphery a series of grooves 12 that may extend from one end of the roll continuously to the other end or which may extend only partially along the length of the roll, depending on the intended application. Positioned in working engagement with the grooved surface of anvil roll 10 are a series of satellite rolls 14, 16, 18 and 20 having about the periphery grooves 22, 24, 26, and 28 that have walls or fins that are shaped and positioned to intermesh or fit within grooves 12 of anvil roll 10. These grooves may also extend continuously along the entire length of any or all of the satellite rolls or partially along the length of any or all of the satellite rolls. Also, if desired, to provide variable stretch properties across the width of the web, the height of the fins or groove walls may vary from one end of one or all the satellite rolls to the other end. The number of satellite rolls that may be employed is not critical, and the satellite rolls are preferably adapted to be moved in and out of engagement so that the number and engagement may be readily varied as desired. The satellite rolls rotate in opposite direction to that of the anvil roll and are desirably driven at speeds matched to the desired effective engagement by one or more motors (not shown).

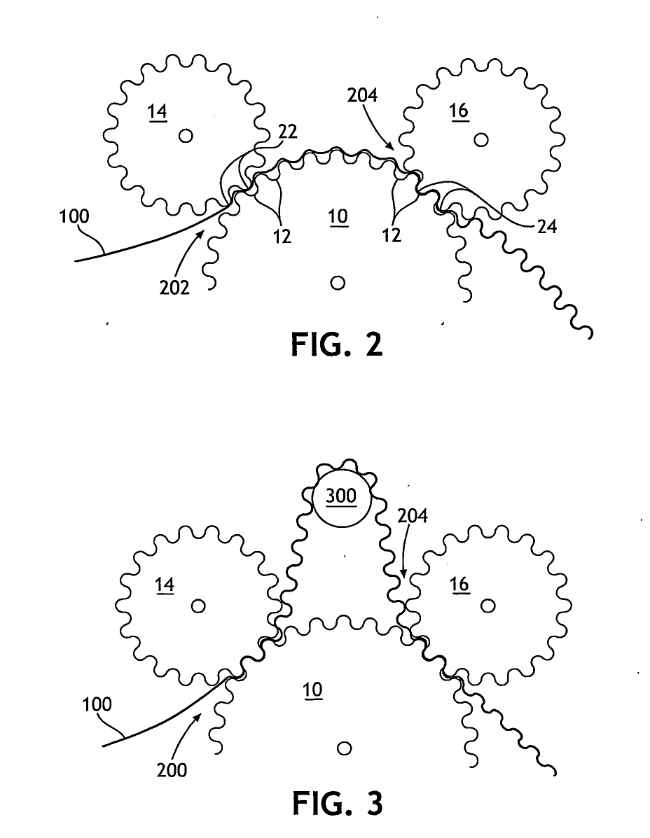

Turning to FIG. 2, there is an enlarged view of the arrangement of FIG. 1 showing the ability to vary the extent to which the meshing fins of the satellite rolls extend into the anvil roll grooves from one satellite roll to another. As shown, fins anvil roll grooves 12 are engaged by meshing with 22 and 24 of satellite rolls 14 and 16 which operate to apply a stretching force to web 100 as the web passes through nips 202 and 204. In this case the fins 22 of satellite roll 14 extend into mating grooves of anvil roll 12 to a lesser extent than do the fins 24 of satellite roll 16. In this manner stretching the machine direction forces applied to web 100 may be gradually increased so that there is a reduced tendency to tear or otherwise damage the web and still stretch to a high degree. It will be apparent that varying the mating engagement of the rolls in this manner may be done with any or all of the satellite rolls and may occur in any order of increasing or decreasing engagement as desired.

Turning to FIG. 3, there is shown an alternative arrangement illustrated in schematic form. The arrangement of FIGS. 1 and 2 tends to provide for multiple impacts on the web along fixed lines across the web as the position of the web on the anvil roll is maintained substantially constant. While this is desirable for many applications, in certain cases it is desirable that the successive impact lines vary or are generally random in location. FIG. 3 illustrates one embodiment for achieving such a result. In this case, web 100 is separated from anvil roll 10 by passing it over idler roll 300 between satellite rolls 14 and 16. As a result, when web 100 returns to nip 204, it's position on anvil roll 10 is changed, and the second lines of impact applied at nip 204 will be displaced from the original lines of impact applied at nip 200. In this way, while the web may be stretched to the same degree overall, web 100 has more surface area that is stretched and the stretching forces are more widely distributed in the web. As is apparent, idler rolls or other means of separating the web can occur at various locations around anvil roll 10 as desired.

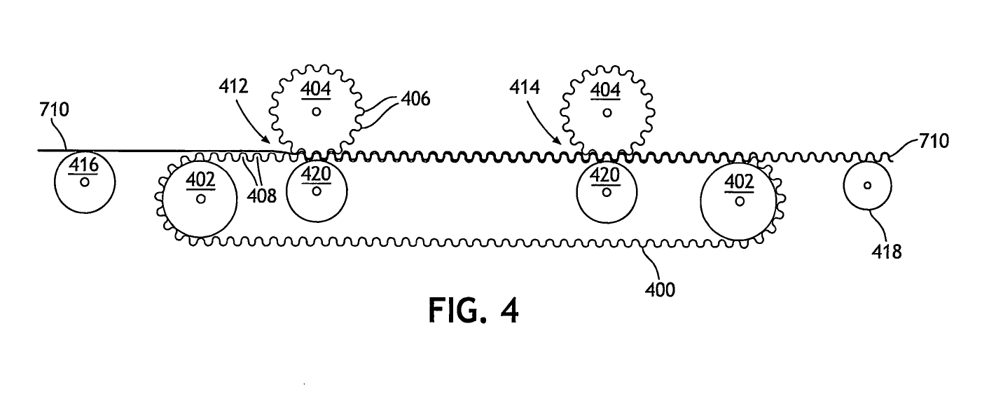

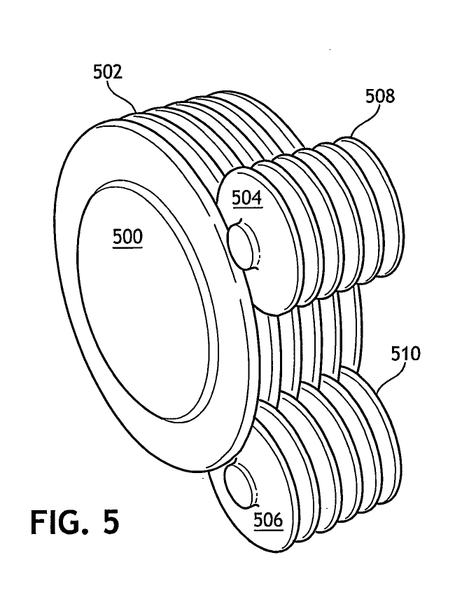

FIG. 4 illustrates a different means for obtaining such multiple impact lines in accordance with the invention. In this case, a grooved belt replaces the anvil roll, and the multiple impact rolls are in line applying working impact on the grooves of the belt. As shown, endless belt 400 passes in a loop around one or more rolls 402, any or all of which may be driven by known means (not shown). Meshing fins 406 of grooved rolls 404 rotate providing intermeshing in grooves 408 of the belt 400 providing stretching forces applied to web 710 as it passes from idler roll 416 and through nips 412 and 414. The stretched web 410 may then be passed over idler roll 418 for winding and/or further processing. As with the embodiment of FIG. 1, the number of meshing rolls and the engagement levels may be varied to achieve desired results. Also as will be apparent, the web may be separated from the belt to achieve random lines of impact as discussed with the embodiment of FIG. 3.

FIG. 5 illustrates an embodiment of the invention wherein the grooves in the anvil and satellite rolls run concentrically around the rolls and, therefore, the web is stretched in the widthwise or cross machine direction. As shown, anvil roll 500 includes grooves 502 and is positioned in working engagement with satellite rolls 504, 506, also having fins 508 and 510, respectively. As with the previous embodiment, it will be apparent that the number of engaging rolls and the engagement depth of the respective rolls may be varied, and the rolls may be partially or fully grooved or grooved to varying extent from one end to the other to provide zoned or full stretching along the roll length as desired.

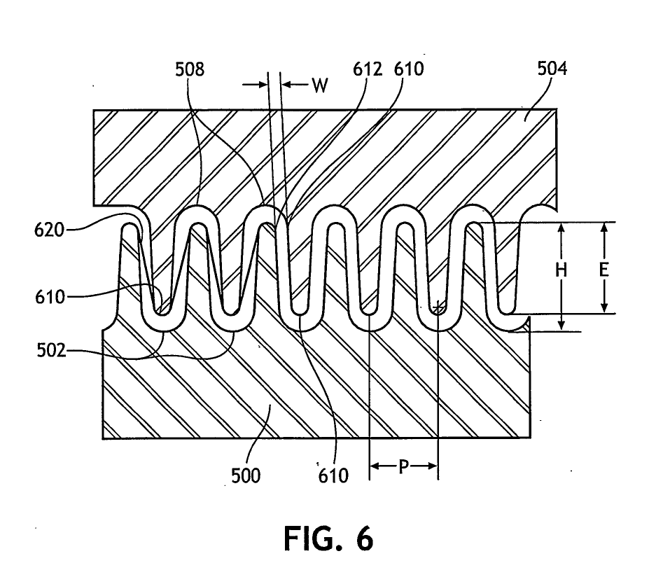

FIG. 6 is an enlarged partial cross sectional view of an engaged nip, for example, for the embodiment of FIG. 5 showing the path of web travel. While, for purposes of more clearly illustrating the nip, the path of web 620 is only shown partially across the nip, it will be apparent that the web may and will normally extend completely across the nip as illustrated in FIGS. 2 and 3, for example. As shown, the grooves 502 of anvil roll 500 intermesh or accommodate the fins 610 between the grooves 508 of satellite roll 504. The intermeshing, in this case, maintains spacing, W, between the respective groove walls 610, 612 that is wider than the thickness of web 620 with the result that the web is stretched without being compressed. As shown, H measures the wall height, and E measures the depth of engagement. The number of grooves per inch, N, is measured by counting the number of walls, tip to tip, per inch along the roll, sometimes also called “pitch”.

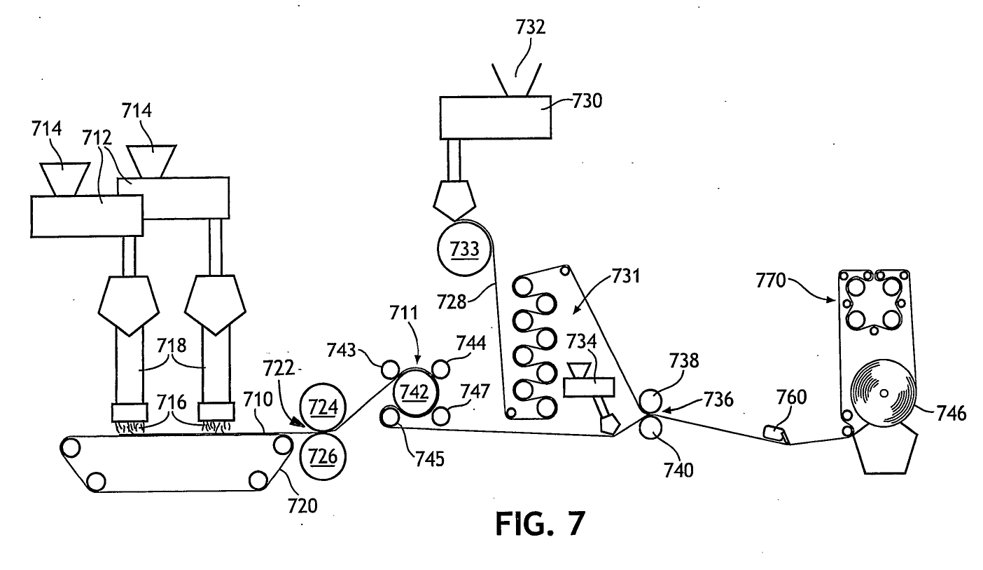

FIG. 7 is a schematic illustration of a film/nonwoven laminating overall process incorporating the stretching process and apparatus of the present invention. As shown, spunbond nonwoven 710 is formed by feeding extruders 712 from polymer hoppers 714 and forming continuous filaments 716 from filament formers 718 onto web former 720. The resulting web 710 is bonded at calender nip 722 formed by a patterned roll 724 and anvil roll 726, one or both of which may be heated to a thermal bonding temperature. After bonding, web 710 is stretched in accordance with the invention using satellite groove roll stretching unit 711 having grooved anvil roll 742 and satellite rolls 744 and an adhesive is applied to the web at adhesive station 734. Film 728 is formed by feeding extruder 730 from polymer hopper 732 and casting onto chill roll 733. The film 728 is stretched by a machine direction orienter (MDO) 731 and the film and spunbond are combined at nip 736 between rolls 738, 740 maintained at a desired adhesive bonding temperature. The laminate is then directed to a slitter 760, if slitting is desired, and to temperature controlled section 770 to chill, retract and/or anneal as desired. Finally, the laminate is directed to winder 746 or, optionally, directed to further processing. For stretching of the laminate, the satellite grooved roll system may be moved to a position following bonding the component layers, if desired. Also, stretching of both one or more of the component layers individually and as a laminate may be carried out in accordance with the invention.

The pitch and number of grooves may be varied widely to achieve desired results. For example for stretching of lightweight laminates of film and nonwoven for disposable personal care product applications such as a backing component, the number of grooves useful may vary from about 3 to about 15 per inch although greater or fewer are contemplated, for example as few as 1 per 10 inches. For such applications, it may be important that the compression of the material be avoided, and the shape of the intermeshing grooves may be selected for that purpose as discussed above. Furthermore, the depth of engagement as the grooves intermesh may also be varied as discussed so as to achieve the desired stretch level. It is a feature of the present invention that high stretch levels may be attained in localized areas in steps of engagement that avoid single, harsh impact that might damage fragile materials.

The rolls may be constructed of steel or other materials satisfactory for the intended use conditions as will be apparent to those skilled in the art. Also it is not necessary that the same material be used for all the rolls, and the anvil roll, for example, may be constructed of hard rubber or other more resilient material so as to impact the flexible web under less stressful conditions. For the belt anvil embodiment, the belt may also be formed of various materials, such as molded natural or synthetic compounds reinforced with cords of high tensile strength fibers or filaments like fiberglass. The facing can be impregnated with nylon or wrapped with durable woven fabric to increase wear resistance and increase belt life. The temperature of one or more of the rolls or anvil surfaces may be controlled by heating or cooling to also change the stretching conditions. In the case of laminate formation, one or more of the component layers may be introduced between the successive impact rolls to result in different levels of stretch applied to one or more of the component layers.

To a significant extent, the material being treated will determine the desired configuration of the equipment. For example, treatment of heavy weight materials may dictate that the spacing and height of the grooves be increased over those parameters for lighter weight materials. Elastic materials may also suggest that the dimensions may be increased without damage to the web; however, for laminates, the less elastic component will also be a consideration.

It will also be apparent to those of skill that biaxially stretching may be achieved by successive use of a machine direction stretch device and a cross machine direction stretch device or reversing this order if desired.

### EXAMPLES

The invention will be illustrated by examples which are representative only and not intended to limit the invention which is defined by the appended claims and equivalents. Modifications and alternatives will be apparent to those skilled in the art and are intended to be embraced by the invention as claimed.

The examples were carried out with equipment under the following conditions unless stated otherwise in the examples:

Conditions

Intermeshing rolls of steel construction and having the dimensions of 66 centimeters (26 inches) in length were constructed. Four satellite grooved rolls of 27 centimeters (10.6 inches) in diameter were mounted around a center grooved roll of 45 centimeters (17.85 inches) in diameter. Concave troughs and corresponding walls or fins were radially formed into the cylindrical surface of the rolls about the circumference generally as shown in FIG. 5. The troughs were at approximately 0.31 centimeters (0.1250 inches) intervals and had a depth of approximately 0.51 centimeters (0.20 inches). The radius of the troughs were approximately 0.10 centimeters (0.040 inches), and the radius of the peaks or fins between troughs were approximately 0.04 centimeters (0.015 inches). All rolls were of a double shell construction to allow a heating fluid such as a mixture of ethylene glycol and water to be pumped through the roll and provide a heated surface. The rolls were positioned in axial alignment (that is parallel alignment of the longitudinal axis of the rolls) that positioned the peaks of the satellite roll fins alignment with the troughs of the anvil roll. The rolls were mounted on bearings and secured within a frame that positioned the satellite rolls at approximately the positions shown in FIG. 7. Nip 1 in the Table below was formed by roll 743 and anvil roll 742, nip 2 by roll 744 and anvil roll 742, nip 3 by roll 747 and anvil roll 742 and nip 4 by roll 745 and anvil roll 742. The satellite rolls and bearings were mounted on sliding plates which moved horizontally away from the center roll. Each satellite roll slide plate was driven by two mechanical actuators and one air motor, which allowed the satellite rolls to be moved about six inches away from the center roll for thread-up and to allow them to be precisely adjusted into the center roll to control the amount of groove engagement.

### Example 1

In Example 1 a film/nonwoven laminate was created. The film layer contained calcium carbonate dispersed in a carrier resin, and an elastomeric letdown resin. Calcium carbonate, for example, available from OMYA, Inc., North America of Proctor, Vt. as designated OMYACARB® 2 SS T having an average particle size of 2 micron, top cut of 8-10 microns and about 1% stearic acid coating was used. The calcium carbonate (75%) and carrier resin (25%), Dowlex 2517 LLDPE (ASTM 1238, Condition E melt index of 25 and density of 0.917 g/cc), compound was then blended in a single screw conventional extruder with 33% of Septon 2004 SEPS triblock thermoplastic elastomer letdown resin to provide a final calcium carbonate concentration of 50.25% by weight. The Dowlex® polymer is available from Dow Chemical U.S.A. of Midland, Mich. The Septon polymer is available from Septon Company of America of Pasadena, Tex.

This formulation was formed into a film by casting onto a chill roll set to 38° C. (100° F.) at an unstretched basis weight of 63 gsm. The film was stretched 3.6 times its original length using a machine direction orienter (MDO), then retracted 35% to a stretched basis weight of 33.9 gsm. As used herein, reference to stretching the film 3.6 times means that a film which, for example, had an initial length of 1 meter if stretched 3.6 times would have a final length of 3.6 meters. The film was heated to a temperature of 52° C. (125° F.) and it was run through the MDO at a line speed of 141.4 meters/min (464 ft/m) to stretch the film. The film was then annealed at a temperature of 71° C. (160° F.) across multiple rolls at a line speed of 103.6 meters/min (340 ft/m).

The fibrous nonwoven web was a 0.45 osy spunbond web made with Exxon 3155 polypropylene, produced by ExxonMobil Corporation, which was made generally as described in US Published Patent Application US 2002-0117770 to Haynes et al., incorporated herein by reference in its entirety and bonded using a wire weave bond pattern looking, as the name suggests, e.g. like a window screen and having a bond area in the range of from about 15% to about 20% and about 302 bonds per square inch.

The fibrous nonwoven web was introduced into all four nips of intermeshing grooved steel rolls set up in a satellite configuration as generally illustrated in FIG. 1 except that the grooves in the satellite and anvil rolls were concentric in the manner shown in FIG. 5. Each roll had a length of about 66 cm (26 inches) with the diameter of the satellite groove rolls about 27 cm (10.6 inches) and the diameter of the main center groove roll about 45 cm (17.85 inches). Each groove was formed with a depth of 0.51 cm (0.200 inch) and with a peak to peak distance of 0.31 cm (0.125 inch) resulting in a maximum draw ratio of 3.4×. In this sample the spunbond was stretched to a maximum draw of 2.24× or 124% in the cross direction (CD) having a velocity of 103.6 meters/min (340 ft/m). The fibrous nonwoven web was heated to a temperature of 110° C. (230° F.) while it passed subsequently through four temperature controlled nips between grooved rolls set to intermeshing engagements of 1.27 mm (0.050 inch) in nip # 1, 1.905 mm (0.075 inch) in nip # 2, 2.54 mm (0.100 inch) in nip # 3 and 3.175 mm (0.125 inch) in nip # 4. The spunbond was drawn 8% in the machine direction between the satellite groove roll unit and the lamination unit causing the CD width to be maintained to its original width of 53.34 cm (21 inches).

Lamination of the two layers was effected using adhesive lamination with a melt spray adhesive die. Rextac 2730 APAO based adhesive, produced by Huntsman Polymers Corporation in Odessa, Tex., was melted to a temperature of 177° C. (350° F.) and applied to the spunbond sheet with an add-on level of 1.5 gsm. The stretched spunbond and film webs were then married together by going through an idler roll providing sufficient pressure to assure full contact and at a speed of about 110.6 meters/min (363 ft/m), an 8% draw from the groove roll unit.

The laminate was then minimally retracted 2% in the machine direction between the lamination unit and the first roll in the annealing unit maintaining its width to 53.34 cm (21 inches). The laminate was then annealed using 4 temperature control rolls. Here the laminate with the spunbond side in contact with the rolls is heated at 82° C. (180° F.) over two rolls and then cooled at 16° C. (60° F.) over the next two rolls to set the final CD stretch material properties. Finally the material was carried with minimal retraction to the winder for a final basis weight of 48 gsm.

### Comparative 1

In the comparative 1 a film/nonwoven laminate was created. The film layer and fibrous nonwoven web were the same as that used in Example 1 except the spunbond was stretched using only one nip instead of four. The spunbond passed through nip # 1 with a set at an engagement of 3.175 mm (0.125 inch).

Lamination of the two layers was performed in the same manner and under the same conditions as in Example 1.

The processing of the laminate was also performed in the same manner and under the same conditions as in Example 1. It was observed that the spunbond was caused to split during the stretching step and the bond points ruptured severely damaging the web.

### Comparative 2

In Comparative 2 another film/nonwoven laminate was created. The film layer and fibrous nonwoven web was the same as that used in Example 1 except the spunbond was stretched using only one nip instead of four. This time the spunbond passed through nip # 4 with a set at an engagement of 3.175 mm (0.125 inch) which resulted in heating of the spunbond by contact with the anvil roll prior to groove stretching.

Lamination of the two layers was performed in the same manner and under the same conditions as in Example 1.

The processing of the laminate was also performed in the same manner and under the same conditions as in Example 1.

In Comparative 2 the spunbond web was destroyed at nip # 4 of the groove roll unit. This is due to the higher web tension force caused by the 8% draw in the machine direction between the satellite groove roll unit and the lamination unit. Higher web tension results in higher local stress at the stretching zone of the nip.

As indicated in the Table below, using the satellite groove roll design, the spunbond has been stretched in accordance with the invention with lower strain rates and compared with single stretch step materials.

Cycle Testing:

The materials were tested using a cyclical testing procedure to determine load loss and percent set. In particular, 2 cycle testing was utilized to 70 percent defined elongation. For this test, the sample size was 3 inch in the MD by 6 inch in the CD. The Grip size was 3 inch width. The grip separation was 4 inch. The samples were loaded such that the cross-direction of the sample was in the vertical direction. A preload of approximately 10-15 grams was set. The test pulled the sample at 20 inches/min (500 mm/min) to 70 percent elongation (2.8 inches in addition to the 4 inch gap), and then immediately (without pause) returned to the zero point (the 4 inch gauge separation). The test repeated the cycle up to 5 times and values at 50% taken. In-process testing (resulting in the data in this application) was done as a 2 cycle test. The results of the test data are all from the first and second cycles. The testing was done on a Sintech Corp. constant rate of extension tester 2/S with a Renew MTS mongoose box (controller) using TESTWORKS 4.07b software. (Sintech Corp, of Cary, N.C.). The tests were conducted under ambient conditions. As used herein the term “percent set” is the measure of the amount of the material stretched from its original length after being cycled (the immediate deformation following the cycle test). The percent set is where the retraction curve of a cycle crosses the elongation axis, and where the strain is zero (at the end of the cycle test).

The “load loss” value is determined by first elongating a sample to a defined elongation in a particular direction (such as the CD) of a given percentage (such as 70, or 100 percent as indicated) and then allowing the sample to retract to an amount where the amount of resistance is zero. The cycle is repeated a second time and the load loss is calculated at given elongation, such as at the 50 percent elongation. The value was read at the 50% elongation level and then used in the calculation. For the purposes of this application, the load loss was calculated as follows:
100× cycle 1 extension tension (at 50% elongation)−cycle 2 retraction tension (at 50% elongation), all divided by cycle 1 extension tension (at 50% elongation)

For the test results reflected in this application, the defined elongation was 70 percent unless otherwise noted. Up values were taken during extension and down values during retraction. The actual test method for determining load loss values is described below.

Samples from the above described examples and the comparative examples were tested for 2-cycle hysteresis collecting strain and strength data, and process amperage data from the groove roll unit rolls were collected. The results are shown in the Table below:

TABLE
Process Data

| | Groove | Roll # | | Roll # | | Roll # | | Roll # | Main |
|---|---|---|---|---|---|---|---|---|---|
| | Pen | 1 | Groove | 2 | Groove | 3 | Groove | 4 | Roll |
| Example | (in) | Amps | Pen (in) | Amps | Pen (in) | Amps | Pen (in) | Amps | Amps |
| 1 | 0.050 | 75% | 0.075 | 75% | 0.100 | 94% | 0.125 | 94% | 97% |
| C1 | 0.125 | 131% | 0.000 | — | 0.000 | — | 0.000 | — | 94% |
| C2 | 0.000 | — | 0.000 | — | 0.000 | — | 0.125 | 131% | 86% |

Material Performance

| | 1^{st} Load | 1^{st} Load | 2^{nd} Load | | | |
|---|---|---|---|---|---|---|
| | @ 50% | @ 50% | @ 50% | 2^{nd} Load @ | Load | % |
| | up/gf | dn/gf | up/gf | 50% dn/gf | Loss | Set |
| Example 1 | 287 | 140 | 199 | 133 | 53 | 11.8 |
| Comparative | **** | **** | **** | **** | **** | **** |
| Examples 1, 2 | | | | | | |

**** Could not be tested due to severe damage during processing.

The above Table demonstrates that the present invention provides the ability to obtain desirable stretch properties without catastrophic defects when compared with conventional groove stretching.

While the invention has been described in detail with reference to specific embodiments thereof, it should be understood that many modifications, additions and deletions can be made thereto without departure from the spirit and scope of the invention as set forth in the following claims.

We claim:

1. A method of incrementally stretching a sheet material comprising the steps of
a. providing a flexible sheet material;
b. providing a forming surface having grooves formed therein;
c. providing a plurality of mating surfaces having fins positioned to fit within the grooves of said forming surfaces;
d. forming successive nips between the forming surface and the mating surfaces wherein the fins of the mating surfaces enter the grooves of the forming surface at separate locations on the forming surface;
e. feeding said sheet material into the successive nips while maintaining the position of said sheet material with respect to said forming surface; and
f. stretching said sheet material a plurality of times along lines on the sheet material by the fins entering the forming surface grooves along with said sheet material within successive nips.

2. The method of claim 1 wherein the fins of said successive mating surfaces enter the grooves of respective successive nips to a different degree providing a different amount of stretch to said sheet at different nips.

3. The method of claim 1 wherein said forming surface is a drum and said plurality of mating surfaces are satellite rolls positioned at different locations with respect to said drum.

4. The method of claim 1 wherein said forming surface is a belt and said fins comprise rolls positioned at different locations with respect to said belt.

5. The method of claim 1 wherein said sheet comprises a nonwoven web.

6. The method of claim 1 wherein said sheet comprises a film.

7. The method of claim 5 wherein said sheet comprises a laminate comprising a film and a nonwoven web.

8. The method of claim 1 wherein said sheet is stretched in the machine direction.

9. The method of claim 1 wherein said sheet is stretched in the cross-machine direction.

10. The method of claim 1 wherein said stretching is along lines having a frequency of about 3 per inch to about 15 per inch.

11. The method of claim 1 wherein said sheet has a basis weight in the range of from about 10 gsm to about 150 gsm.

12. The method of claim 1 further including the step of separating said sheet from said support surface and returning it to said support surface at least once between at least one pair of said nips.

13. Apparatus for incrementally stretching a web with multiple impacts comprising:
a. means for providing a flexible web;
b. a forming surface having grooves formed therein;
c. means for depositing said flexible sheet on said forming surface;
d. a plurality of nip forming means having fins adapted to movably fit within said forming surface grooves creating a plurality of nips;
e. means for feeding said sheet on said forming surface into said plurality of nips;
f. means for engaging said nip forming means and said sheet on said forming surface causing said fins to enter the forming surface grooves and stretch said sheet.

14. The apparatus of claim 13 wherein said support surface comprises an anvil roll and said nip forming means comprises a plurality of satellite rolls.

15. The apparatus of claim 13 further including means to adjust the distance that the fins of said nip forming means enter said grooves.

16. The apparatus of claim 13 wherein said support surface comprises a belt.

17. The apparatus of claim 13 wherein said forming surface grooves and said nip forming means fins are adapted to stretch said web in the machine direction.

18. The apparatus of claim 13 wherein said forming surface grooves and said nip forming means fins are adapted to stretch said web in the cross-machine direction.

19. The apparatus of claim 13 wherein the fins of at least one of said nip forming means are adapted to enter said forming surface grooves to a different extent from one end of said nip forming means to the other end in the cross machine direction of said sheet.

20. The apparatus of claim 13 wherein said fins have a spacing within the range of from about 3 per inch to about 15 per inch.

21. The apparatus of claim 13 further including means to separate said sheet from said forming surface and return it to said forming surface between at least one of said plurality of nips.

22. A sheet stretched in accordance with the process of claim 1.
